(19) United States
(12) Patent Application Publication
(10) Pub. No.: US 2013/0261326 A1
(43) Pub. Date: Oct. 3, 2013

(54) PROCEDURE FOR STABILISING POLYUNSATURATED FATTY ACIDS WITH METAL HYDRIDES

(71) Applicants: Giuseppe Guazzi, Rozzano (MI) (IT); Lodovico Vezzoli, Rozzano (MI) (IT)

(72) Inventors: Giuseppe Guazzi, Rozzano (MI) (IT); Lodovico Vezzoli, Rozzano (MI) (IT)

(73) Assignee: Prime European Therapeuticals S.p.A. in forma abbreviata EUTICALS S.p.A., Milano (IT)

(21) Appl. No.: 13/991,543

(22) PCT Filed: Dec. 6, 2011
(86) PCT No.: PCT/EP2011/071878

§ 371 Date: Jun. 4, 2013

(30) Foreign Application Priority Data
Dec. 15, 2010 (IT) MI2010A002297

(51) Int. Cl. C11B 7/00

(52) U.S. Cl. CPC C11B 7/0083
USPC 554/208

(57) ABSTRACT

The invention relates to a procedure for stabilising polyunsaturated fatty acids with selective reducing agents. In particular, the invention relates to a process of preparation of polyunsaturated acids of the omega-3 series, as such or in the form of esters, which comprises treatment of fish oil or a mixture of acids with urea, and subsequent treatment with a metal hydride, preferably sodium borohydride. The polyunsaturated fatty acids of greatest interest present in fish oil are docosahexaenoic acid (DHA) and eicosapentaenoic acid (EPA).

The present invention discloses a process for the preparation of polyunsaturated omega-3 fatty acids or esters thereof, in isolated form or in a mixture, from oils or mixtures containing them, which said process comprises a step of selective enrichment by precipitation of urea adducts in the presence of reducing agents.

The products obtainable from the process according to the invention are used in the food and pharmaceutical industries.

### STATE OF THE ART

The term “omega-3 acids”, or simply “omega-3”, means polyunsaturated fatty acids having a double bond in position ω-3; they normally have 18 to 22 carbon atoms and 3 to 6 unsaturations. The most common types of omega-3 are α-linolenic acid (C18:3), moroctic acid (C18:4), eicosatetraenoic acid (C20:4), eicosapentaenoic acid (C20:5; commonly called EPA), heneicosapentaenoic acid (C21:5), clupanodonic acid (C22:5) and docosahexaenoic acid (C22:6; commonly called DHA).

Omega-3 such as DHA, EPA and esters thereof, in particular the ethyl esters, are normally used in the food and pharmaceutical industries for the treatment and/or prevention of cardiovascular diseases and/or events such as myocardial infarction.

The mixture commonly used for these purposes is defined as ethyl esters of omega-3 90 acids, and is characterised according to European Pharmacopoeia 5.0 by a minimum content of 80% EPA and DHA ethyl esters, with a minimum of 40% EPA ethyl ester and a minimum of 34% DHA ethyl ester.

The preparation of fatty acids and/or esters in the omega-3 series is described in various patents and publications: WO 8703899 discloses a process of purification from marine oil by fractionated crystallisation in the presence of urea, which comprises initial esterification or transesterification of the oil. Said process produces a concentrated fish oil containing at least 20% EPA and at least 35% DHA.

U.S. Pat. No. 4,377,526 discloses a method for purifying EPA and the esters thereof, comprising treatment of a mixture containing EPA or esters thereof with urea in a polar organic solvent, filtration and fractionated distillation of the mixture.

WO 9421766 discloses a process for the separation of DHA or an ester thereof, which comprises separation of a lipid containing it from a marine microalgae and separation of DHA from the mixture obtained by hydrolysis of the lipids, and subsequent esterification with a lower alcohol or with an ester obtained by transesterifying said lipid. The product obtained is purified by dissolving it in a mixture of urea and solvent. The solvent is then evaporated and distilled, and the product is finally extracted with a solvent in which urea is substantially insoluble, whereas DHA or the ester thereof is soluble.

Processes for obtaining mixtures rich in omega-3 fatty acids and/or esters thereof are also discloses in EP 271747, WO 2003089399 and WO 0151598.

### DESCRIPTION OF THE INVENTION

The present invention relates to a process for the preparation of mixtures having a high content of omega-3 fatty acids. The process according to the invention comprises a step of selective enrichment by precipitation of urea adducts associated with the use of reducing agents to reduce the oxidation processes.

The expression “mixtures having a high content of omega-3 acids” means mixtures of fatty acids and/or esters thereof having a content of omega-3 acids or esters thereof, preferably ethyl esters, exceeding 80% by weight; the esters are preferably esters of C1-C4 alcohols, having 1 to 3 hydroxyl groups. In particular, the process according to the invention relates to the preparation of mixtures complying with the European Pharmacopoeia, namely mixtures with an 80% minimum content of EPA and DHA ethyl esters, with a minimum of 40% EPA ethyl esters and a minimum of 34% DHA ethyl esters, and a 90% minimum content of ethyl esters of omega-3 acids. The process according to the invention also produces purified EPA or DHA, each with an assay of at least 80%.

It has surprisingly been found that the use of metal hydrides as reducing agents produces anisidine number and peroxide number values in accordance with the specifications laid down by the European Pharmacopoeia, which could not otherwise be achieved with the processes described to date.

It has been found in particular that the use of complex metal hydrides, such as sodium borohydride and the like, in an amount comprised between 0.1 and 20% by weight, is crucial to reduce the presence of peroxides caused by the oxidation process during the enrichment, distillation, separation, extraction and filtration steps characterising the production of polyunsaturated fatty acids and esters thereof. The hydride is preferably added in solid form to the oil, the EPA/DHA mixture or the starting material containing EPA or DHA.

The process according to the invention can be applied to natural oils containing EPA and DHA and/or esters thereof in various ratios, preferably fish oil.

Crystallisation with urea in organic solvents, in particular alcohols such as methanol or ethanol, possibly mixed together and/or with water, allows selective enrichment of omega-3 acids or esters, namely an EPA/DHA mixture or isolated DHA or EPA with a purity of at least 80% by weight.

The process according to the invention leads to a reduction in the anisidine and peroxide numbers which, according to the European Pharmacopoeia, are indicators of the oxidation process and partial glyceride content.

The mixtures obtained are enriched with EPA esters or DHA esters, depending on the initial content of said acids and/or esters of the omega-3 series.

### DETAILED DESCRIPTION OF THE INVENTION

Natural or derivatised fish oils, comprising a mixture of EPA and DHA ethyl esters or EPA alone or DHA alone at a high concentration, are treated with urea in an amount comprised between 1 kg and 3 kg for 1 kg of fish oil. The urea can be added in solid form or in methanol or ethanol solution. The mixture is then cooled to the temperature of 0°-25° C. in a period of between approx. 1 and 8 hours in the presence of a quantity of sodium borohydride (or metal hydride having similar properties, such as LiCNBH₄) sufficient to obtain omega 3 with a low peroxide content and an anisidine number of less than 20. The hydride is preferably added in solid form in percentages by weight of between 0.1 and 20%, preferably between 1 and 10%, of the total oil or starting material enriched with EPA and/or DHA.

Treatment with the hydride is performed at a temperature of between 0° and 50° C. or, in the event of use of a solvent and fish oil as starting material, at a temperature of between 0° and 100° C.

The invention is described in detail in the following example.

### Example

100 g of fish oil is treated with 50 g of urea, heated to obtain a solution, gradually cooled to 10° C., filtered and distilled under vacuum. The residue is extracted with water and separated.

The oil is treated with 1 g of sodium borohydride at the temperature of 25° C. for 1-2 hours and filtered, to obtain 80 g of oil having a 40% EPA content and a 34% DHA content. The anisidine number is 3.5.

1. A process for the preparation of omega-3 polyunsaturated fatty acids or the esters thereof, in isolated form or in a mixture, from oils or mixtures containing them, which process comprises selectively enriching by precipitation urea adducts in the presence of reducing agents.

2. A process according to claim 1, wherein the polyunsaturated fatty acids are eicosapentaenoic acid (EPA) and docosahexaenoic acid (DHA) and the corresponding ethyl esters.

3. A process according to claim 1, wherein mixtures of omega-3 polyunsaturated acids having an 80% minimum content of EPA and DHA ethyl esters, with a minimum of 40% EPA ethyl esters and a minimum of 34% DHA ethyl esters, and a 90% minimum content of ethyl esters of omega-3 acids, are obtained.

4. A process according to claim 1, wherein the reducing agent is sodium borohydride.

5. A process according to claim 4, wherein sodium borohydride is used in amounts ranging from 0.1 to 20% by weight of the total mixture or oil to be treated.

6. A process according to claim 5, wherein sodium borohydride is added in a solid form.

7. A process according to claim 4, wherein hydride treatment is carried out at a temperature ranging from 0° to 50° C. or, when using a solvent and fish oil as starting material, at a temperature ranging from 0° to 100° C.

8. A process according to claim 4, wherein crystallization by means of urea is carried out in methanol or ethanol, while cooling the mixture to a temperature of 0°-25° C. in a time ranging from about 1 to 8 hours.

9. A process according to claim 8, wherein the crystallization is carried out in methanol and ethanol mixed together and/or with water.
